(19) United States
(12) Patent Application Publication
(10) Pub. No.: US 2002/0156713 A1
(43) Pub. Date: Oct. 24, 2002

(54) Method of performing financial transactions by means of a telecommunication network and a system for implementing the method

(75) Inventor: Francesco Maria Gaini, Milano (IT)

Correspondence Address: KALOW & SPRINGUT LLP, 488 MADISON AVENUE, 19TH FLOOR, NEW YORK, NY, 10022, US

(73) Assignee: Fundsworld Financial Services Limited, Dublin (IE)

(21) Appl. No.: 10/100,940

(22) Filed: Mar. 18, 2002

Related U.S. Application Data
(63) Continuation of application No. PCT/IB00/00993, filed on Jul. 18, 2000.

(51) Int. Cl. G06F 17/60

(52) U.S. Cl. 705/36

(57) ABSTRACT

A method (403) of performing financial transactions by means of a telecommunication network comprising a client computer associated with an investor having predetermined assets and a server computer for association with a service center, the method comprising the steps of: transmitting (405), from the server computer to the client computer, a first set of financial quantities associated with a first plurality of investment products which define a first portfolio of the investor, displaying (405) the first set of financial quantities on the client computer, making (406) at least one change to the first set of financial quantities by means of the client computer so as to generate a second set of financial quantities associated with a second plurality of investment products, establishing (408) a second portfolio in a manner correlated with the financial quantities of the second set, and displaying (409), under the control of the client computer, a summarized representation of the first portfolio and a summarized representation of the second portfolio which permit a comparison between the first portfolio and the second portfolio.

### The present invention relates to a method of performing financial transactions by means of a telecommunication network.

The possibility of purchasing products or making use of services of various types by means of electronic processors connected by means of telecommunication networks seems to be of great interest to an increasing number of users. The best known of these networks for telecommunication between electronic processors is the so-called INTERNET. Computers exchange information on the INTERNET with the use of various services, amongst which a place of primary importance is held by the so-called “World Wide Web” (“WWW”)

A group of products and services which seem particularly suitable for being offered to users by means of a telecommunication network are those of a financial nature.

Amongst known financial services, those relating to mutual funds are valued to an ever greater extent by the public. In general, this type of investment can be made even by investors who do not have any particular economic/financial knowledge.

Moreover, the offer of these services on a telecommunication network seems very advantageous, since it allows investors to follow the behaviour of their investments constantly and to perform a financial transaction simply by means of a connection to the telecommunication network by means of an electronic processor such as a simple personal computer.

In general, each investment fund is managed by a management company, and the individual investor exchanges information and requests with a service centre which acts as an intermediary with the management company.

Typically, an investor's financial resources are distributed over several investment funds. According to the behaviour of the financial market, the investor may wish to change this distribution of his resources between these funds, for example, by purchasing a certain number of shares of one fund and selling shares previously purchased in another fund.

It is pointed out that, as the number of financial transactions to be performed increases, the method by which the investor can arrange the desired transactions by means of the service centre becomes more and more important. For a relatively large number of financial transactions such as the sale or purchase of shares in several funds, these methods of connection and communication between the investor and the service centre, which require long periods of time and which are over complex, may discourage the use of the financial service by means of the telecommunication network for many potential investors. This problem assumes particular importance for those investors who do not have specific knowledge of the field.

The object of the present invention is to provide a method of performing financial transactions by means of a telecommunication network which reduces the time for which the investor is connected to the telecommunication network in comparison with conventional methods and which is easy for investors to use.

The object of the present invention is achieved by a method of performing financial transactions by means of a telecommunication network, comprising a client processing system for association with an investor having predetermined assets and a server processing system for association with a service centre, the method comprising the steps of:

transmitting, from the server processing system to the client processing system, a first set of financial quantities associated with a first plurality of investment products purchased by the investor, the assets being distributed amongst the first plurality of products in a manner correlated with the quantities of the first set in order to define a first portfolio of the investor,

displaying the first set of financial quantities under the control of the client processing system,

making at least one change to the first set of financial quantities by means of the client processing system so as to generate a second set of financial quantities associated with a second plurality of investment products,

transmitting the second set of financial quantities to the server processing system,

establishing a distribution of the assets amongst the second plurality of products in a manner correlated with the financial quantities of the second set in order to define a second portfolio,

displaying, under the control of the client system, a summarized representation of the first portfolio and a summarized representation of the second portfolio which permit a comparison between the first portfolio and the second portfolio.

The characteristics and the advantages of the present invention will become clear from a reading of the following detailed description of a preferred embodiment thereof, provided purely by way of non-limiting example with the aid of the appended drawings, in which:

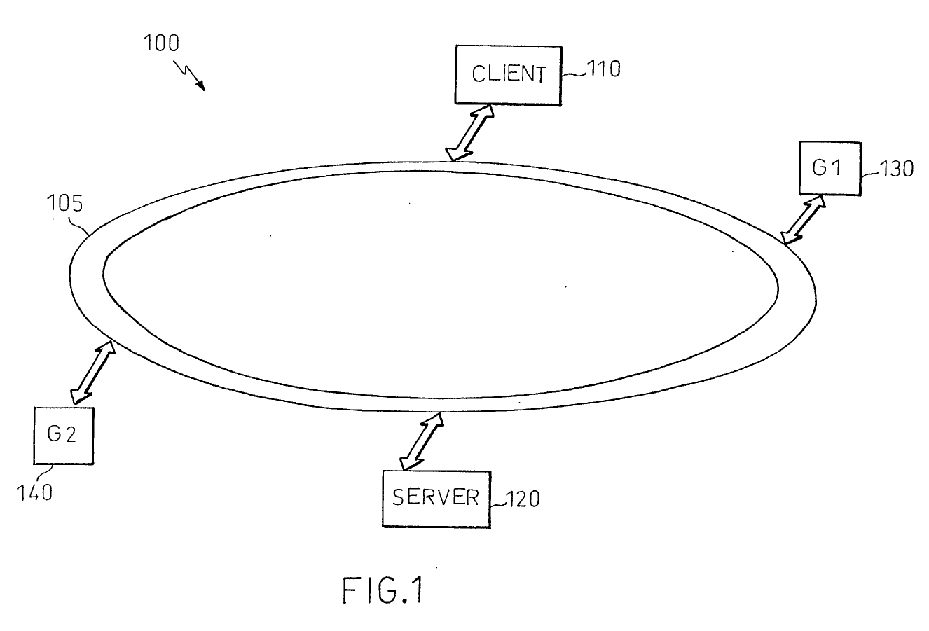

FIG. 1 shows a system for performing financial transactions, formed in accordance with the invention,

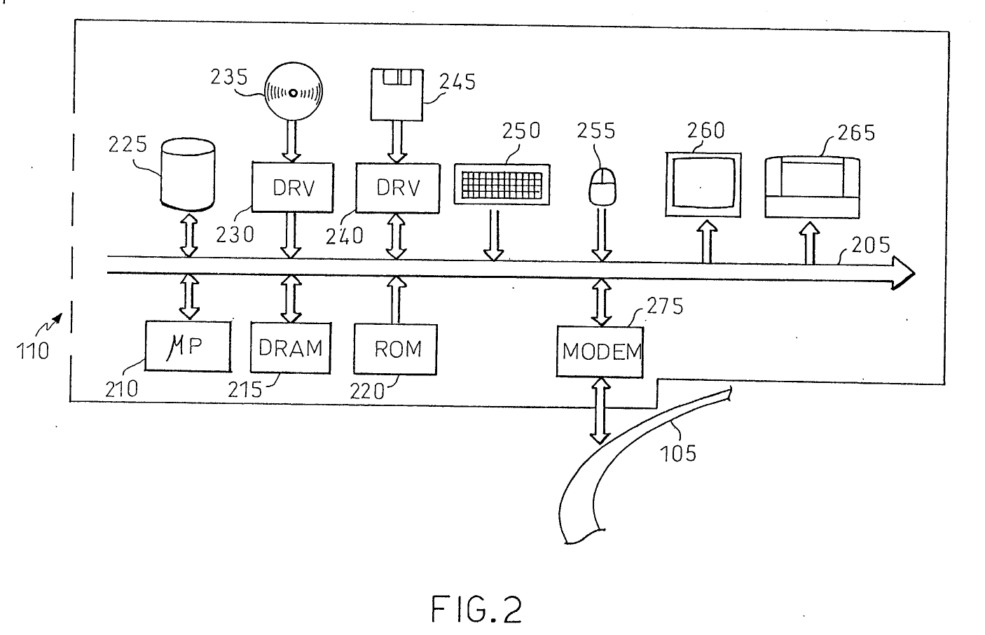

FIG. 2 shows schematically a client computer usable in the system of FIG. 1,

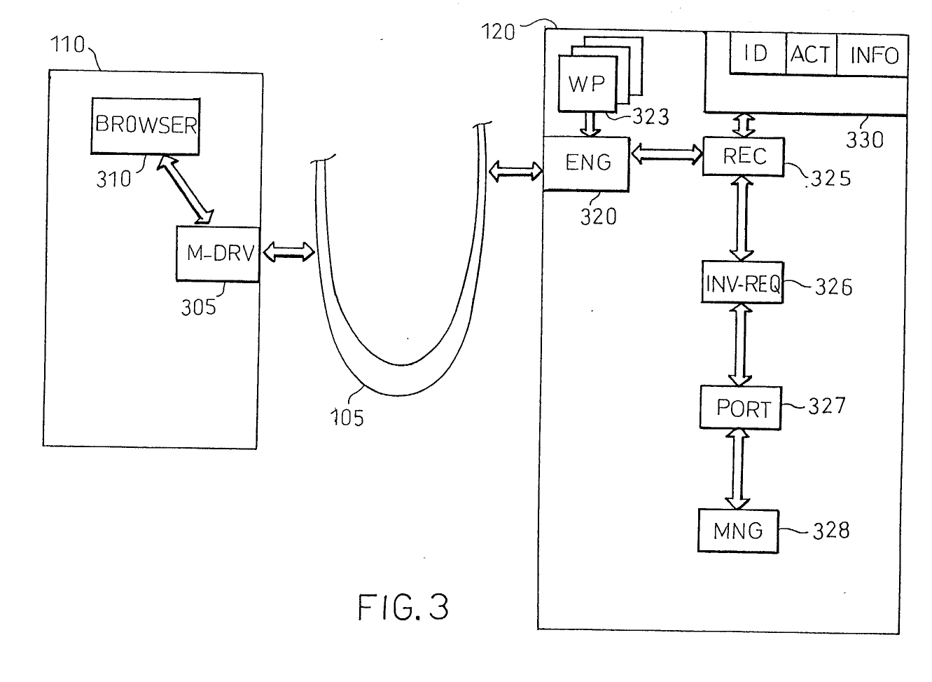

FIG. 3 shows schematically the content of the working memories of the client computer and of the server computer according to the invention,

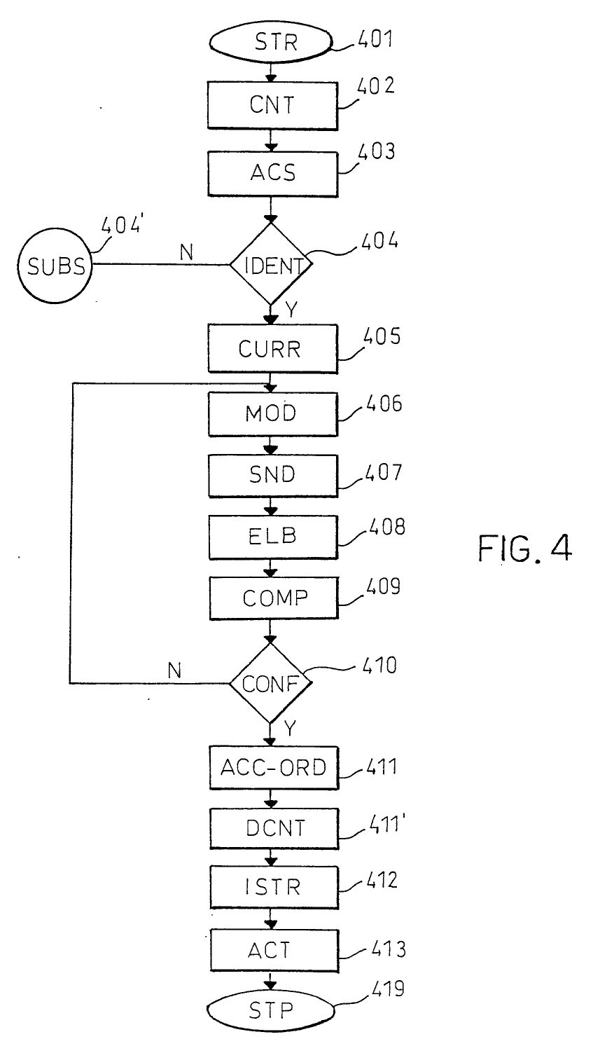

FIG. 4 shows, by means of a flow chart, a method of performing financial transactions according to the invention,

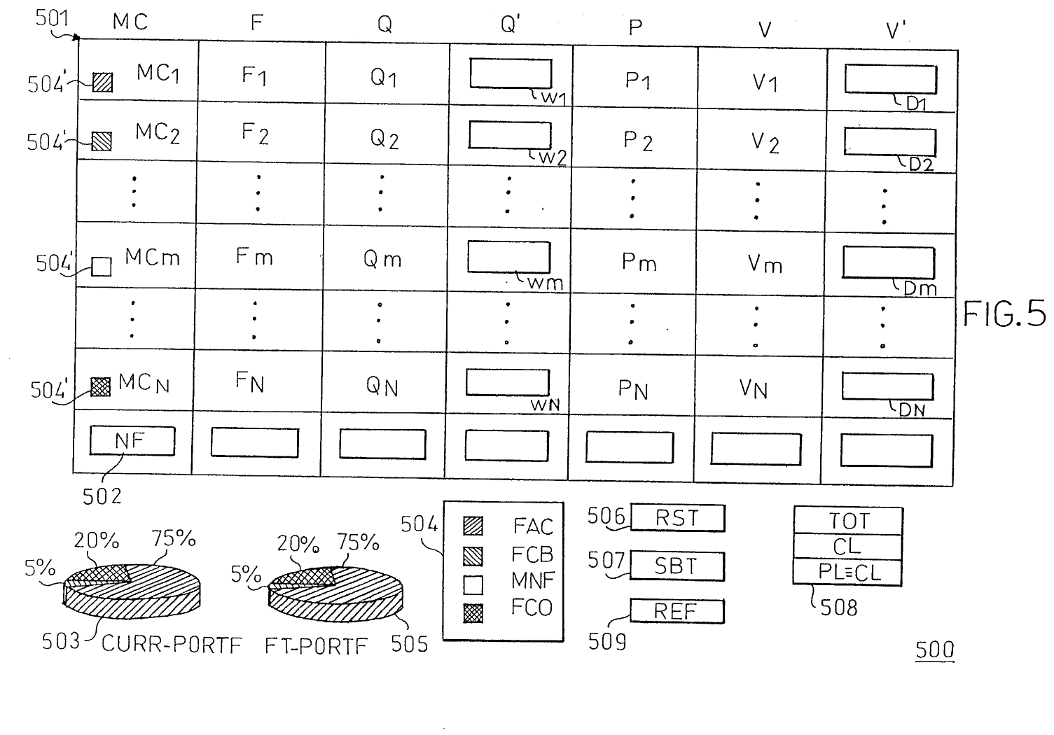

FIG. 5 shows a first web page formed in accordance with the invention,

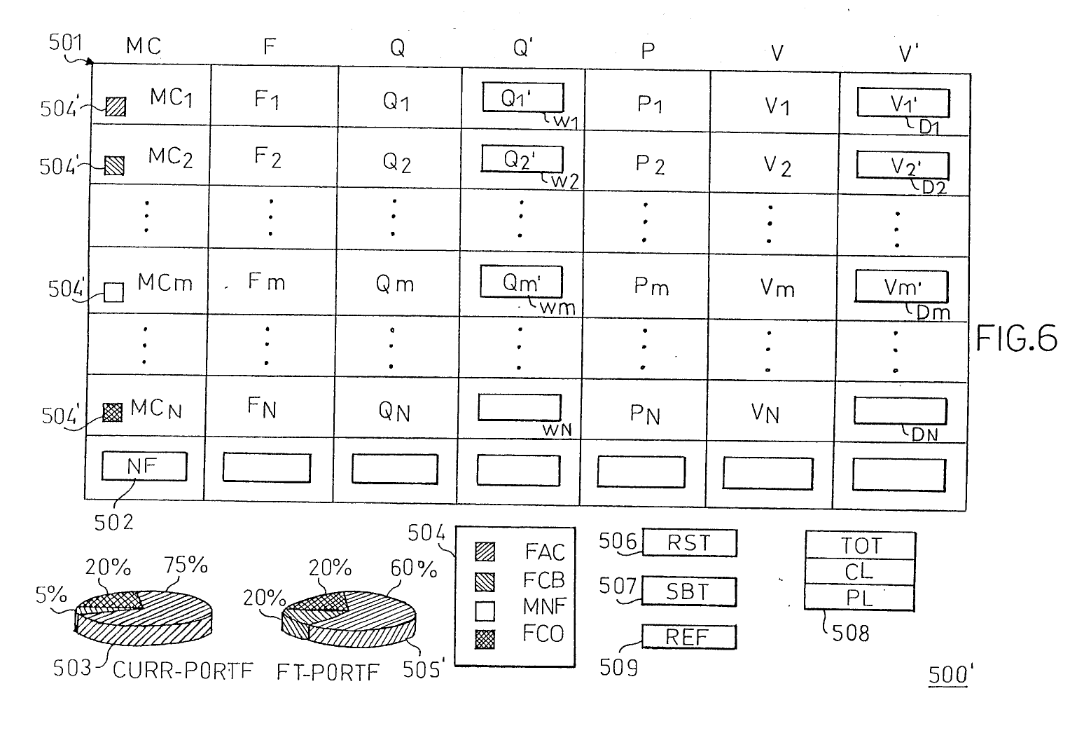

FIG. 6 shows a second web page formed in accordance with the invention,

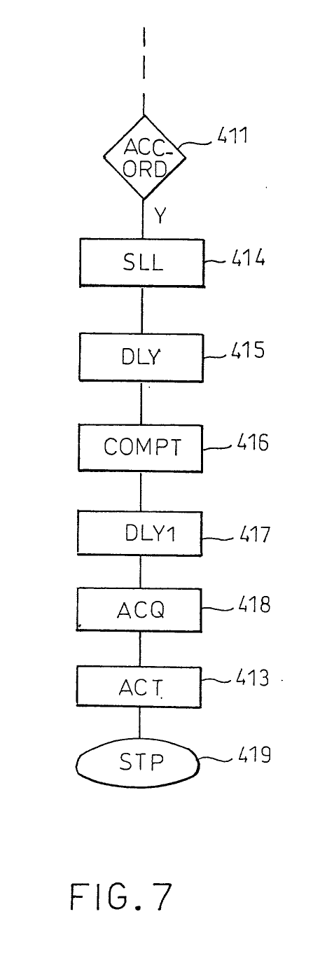

FIG. 7 shows, by means of a flow chart, some alternative steps of the method according to the invention of FIG. 4.

As is known, mutual funds are divided into various categories which differ from various points of view. Within the same category, the funds have common characteristics relating to the type of investment. In particular, mutual funds can be divided on the basis of a scheme which follows the Standard International Classification (SIC). For example, some categories identified by this standard are: stock mutual funds (FAC), balanced mutual funds (FCB), money-market mutual funds (MMF), and bond mutual funds (FCO).

Each of these categories in turn is subdivided into sub-categories corresponding to economic/geographical areas Aᵢ, to which the funds in question belong. For example, some of these sub-categories are: Euro Zone (A₁), Europe (A₂), America (A₃), Emerging countries (A₄).

Each individual fund is identified by a name Fᵢ and is managed by a fund-management company MCⱼ.

For each fund, there is an associated plurality of financial quantities which characterize the fund and which define the state of the investments in that fund. In greater detail, the following financial quantities are associated with a specific fund Fᵢ of a management company MCᵢ: the price Pᵢ of each share q in the fund, the number Qᵢ of shares owned by the investor, and an equivalent value Vᵢ which is equal to the product of the number of shares and the price per share, Vᵢ=Qᵢ*Pᵢ.

An investor can perform a financial transaction relating to a specific fund. The expression “financial transaction” is intended to define the purchase or sale of one or more shares q of a fund Fᵢ at a price Pᵢ.

The investor has available a predetermined amount of financial resources, that is to say, assets, which he invests in these funds.

For the purposes of the present invention, the term “portfolio” is intended to define the distribution of the investor's assets amongst the categories or the sub-categories according to which the investment funds can be classified (in English, the “asset allocation”). For example, if the assets are indicated C, the investor may have the following portfolio: 20% of C in FAC, 30% of C in FCB, 25% of C in MMF, and 25% of C in FCO.

The investor's portfolio is changed as a result of one or more financial transactions such as, for example, the sale of some shares in a fund belonging to one category and the purchase of shares in another fund belonging to another category.

A system and a method according to the present invention for performing financial transactions by means of a telecommunication network will now be described.

With reference in particular to FIG. 1, this shows a system 100 comprising a telecommunication network 105, typically the INTERNET (INTERnational NETwork). The INTERNET is a global network of processing systems with a decentralized structure. In general, the processing systems of the INTERNET use a client/server architecture in which a remote processing system (a server) provides information and services to a local processing system (a client). The INTERNET provides for various access protocols; in particular, the World Wide Web (WWW) permits access to a subset of servers (known as web sites) which support the management of hypertext documents known as web pages. Each web page is constituted by a file in HTML (hypertext markup language) format which permits links to other documents.

A client processing system 110, hereinafter referred to as the client computer, is connected to the network 105.

With reference to FIG. 2, the client computer 110, typically a personal computer, includes various units which are connected in parallel to a communication bus 205. In particular, a microprocessor (μP) 210 controls the operation of the computer 110, a working memory 215, typically a DRAM (dynamic random access memory), is used directly by the microprocessor 210, and a read-only memory (ROM) 220 contains a basic program (bootstrap) for starting up the computer 110.

Various peripheral units are also connected to the bus 205 (by means of respective interfaces). In particular, there is a bulk memory consisting of a hard disk 225, of a drive device (DRV) 230 for reading optical disks (CD-ROMs) 235, and of a drive device (DRV) 240 for reading/writing floppy disks 245.

The client computer 110 includes an input unit comprising a keyboard 250 and a desktop pointing device (a mouse) 255, an output unit which consists of a monitor 260 and of a printer 265, and a MODEM (MOdulator DEModulator) 275 for connection to the telecommunication network 105.

With reference to FIG. 3, the computer 110 includes, in addition to an operating system and various applications programs (not shown in the drawing), a drive module (M-DRV) 305 which physically controls the transmission of information on the telecommunication network 105 by means of the MODEM. The MODEM drive module 305 communicates with a browser module 310 for access to the Web.

Similar considerations apply if the computer has a different structure, for example, if it is constituted by a central unit to which various terminals are connected, or by a computer network, or if it has other units such as a scanner, a web video camera (a web-cam), and the like.

The system 100 also includes a service centre with which a server processing system 120, hereinafter referred to as the server computer, connected directly to the telecommunication network 105, is associated. In the particular embodiment described, the service centre performs the functions of a financial dealer operating as an intermediary between the investment fund-management company and at least one investor who is using the client computer 110. However, further intermediaries (for example, banks) responsible for dealing in shares on the account of the fund-management company may be provided between the service centre and a fund-management company. It will be clear to an expert in the art how to apply the teachings provided by the present description to a situation in which such further intermediaries are provided.

The server computer 120 can exchange with the client computer 110 data relating to the investments made by the investor and can receive from the client computer 110 orders to execute financial transactions.

The service centre and, in particular, the server computer 120 can communicate with computers Gᵢ belonging to a plurality of fund-management companies. For example, the computers Gᵢ and the server 120 may be connected by means of the same network 105 or by means of dedicated networks (not shown in the drawings).

FIG. 1 shows schematically, two computers G₁ 130 and G₂ 140 connected to the network 105 in order to exchange data relating to respective managed investment funds and to receive, from the server computer 120, instructions to execute the orders transmitted by the investor.

The server computer 120 includes, in addition to an operating system and to various administrative programs (not shown in the drawing), an engine (ENG) 320 for controlling communication with the telecommunication network 105. The server computer 120 also comprises, in a bulk memory thereof, various web pages (WP) 323. The web pages 323 can be transmitted to the computer 110 (by means of the telecommunication network 105) under the control of the engine 320.

The engine 320 communicates with an identification module REC 325 which is connected to a database of investors 330 stored in the bulk memory of the server computer 120.

The database of investors 330 is constituted by one or more relational tables. These tables contain a record for each investor (for example, several thousand records); the record consists of a field containing an investor identification code (ID), of an investor activation indicator (a flag) (ACT), and of a field INFO containing the financial information relating to the investor such as, for example, information relating to the investor's portfolio and to his assets.

It should be noted that, at the service centre, there is a supporting current account into which the investor's financial resources are paid or, alternatively, these financial resources are paid into a bank which is in contact with the service centre by means of the network 105 or by means of a dedicated network.

The identification module REC 325 is also connected to a collating module INV-REQ 326 for storing data of various types such as financial quantities relating to investment funds and codes relating to orders for the execution of financial transactions transmitted by the investor by means of the client computer 110.

The module INV-REQ 326 is connected to a calculation module PORT 327 for establishing the corresponding portfolio on the basis of the financial quantities relating to the investment funds present in the collating module INV-REQ 326 and on the basis of the investor's assets.

The module PORT 327 is connected to an order management module MNG 328 suitable for managing the execution order transmitted by the investor and for generating corresponding instructions to be transmitted to the computers 130 and 140 associated with the investment fund-management companies G₁ and G₂.

FIG. 4 shows, by means of a flow chart, a method by which an investor can perform one or more financial transactions.

This method may be implemented, for example, by means of the system 100 described above.

The method starts in the start box STR 401 and continues with a connection box CNT 402 corresponding to the connection of the investor, by means of the client computer 110, to a web site of the service centre which is made available on the telecommunication network 105 by the server computer 120.

The investor gains access to the web site of the service centre 120 by means of the MODEM driver module 305 which communicates with the browser 310.

The server computer 120 transmits, by means of the engine ENG 320, a series of web pages which will be displayed by the investor on the monitor 260.

The investor can request access to a financial service according to the present invention from one of these web pages. The request for access to the service, corresponding to box ACS 403, may be made by selecting, by means of the mouse 255, a suitable “hot spot” present on the web pages produced in HTML format and transmitted to the server computer 120.

Preferably, as a result of this selection by the investor, and in a step IDENT 404, a web page is displayed by means of which the server computer 120 requests a code ID identifying the investor. After the investor's identification code ID has been typed in by means of the keyboard 250, it is sent by the client computer 110 to the server computer 120.

The identification code ID is compared with the identification codes present in the database 330 by the identification module REC 325. If the investor is not recognized, he is not permitted access to the financial service and a web page on which information relating to the financial service is displayed is preferably transmitted in step SUBS 404′.

If the identification has a positive outcome, the activation indicator ACT of the database 330 is put in a state corresponding to the entitlement of the investor to access the financial service.

In the next step CURR 405, the server computer 120 retrieves from the field INFO of the database 330 the data relating to the current portfolio of that investor. The current portfolio is the portfolio corresponding to the current state of the investments. The server computer 120 transmits to the client computer 110, by means of the engine ENG 320, a web page 500 shown in FIG. 5, which shows a first set of financial quantities relating to the current portfolio.

The web page 500 comprises a table 501, the lines of which together show a first set of financial quantities relating to N investment funds available to the investor.

The table 501 comprises a column MC in which the managers of the funds MC₁-MC_{N} are listed, a column F in which the names of the funds F₁-F_{N} are listed, a column Q in which the numbers Q₁-Q_{N} of shares purchased by the investor for each fund are given, a column P in which the latest known prices P₁-P_{N} of each share in the fund are given, and a column V in which the current equivalent values V₁-V_{N} of the resources invested in that fund are given. It is pointed out that each current equivalent value Vᵢ is equal to the product of the number of shares Qᵢ and the latest known price Pᵢ.

The first set of financial quantities relating to the current portfolio comprises the above-defined quantities Q₁-Q_{N}, P₁-P_{N}, V₁-V_{N}.

It is pointed out that the way in which transactions take place in a financial market is such as to allow a service centre such as that with which the server computer 120 is associated to receive the value of the price of a single share each day, but this price relates to the previous day.

The web page 500 also comprises a summarized representation CURR-PORTF 503 of the current portfolio which shows how the investor's assets are divided amongst the various categories of mutual funds.

In the specific example of FIG. 5, this summarized representation uses a “three-dimensional pie chart” representation with sectors of various colours each having a volume proportional to the percentage of the assets invested in a respective category.

Alternatively, other forms of summarized representation, for example, using either two-dimensional or three-dimensional areas, bars, histograms, lines, or rings may be used instead of the pie chart. Moreover, a tabular representation giving the percentages relating to each category of funds may be used instead of a graphic representation.

Furthermore, rather than representing the distribution of the assets amongst the categories FAC, FCB, MMF, FCO, the CURR-PORTF 503 may represent the distribution of the assets amongst the sub-categories relating to the economic/geographical areas A₁-A₄ or in accordance with other classifications of the funds for example, by fund-managing company.

It seems clear that the financial quantities indicated above, together with the names of the funds, the assets invested by the investor, and a predetermined classification of the funds, enable the corresponding portfolio to be defined.

A legend 504 associated with the summarized representation 503 relates the colour of each sector with the particular corresponding category (in the specific example, FAC, FCB, MMF, FCO). For example, the current portfolio of the page 500 has 75% of the resources invested in FAC funds, 20% invested in FCO funds, 5% in FCB funds and 0% in MMF funds. It is pointed out that, in the table 501, for each line relating to a fund Fᵢ, there is an indicator 504′ of the category to which the fund belongs. For example, this indicator is a box having one of the colours tabulated in the legend 504.

The web page 500 enables the investor to see the values of the first set of financial quantities relating to the current portfolio and to make changes to these quantities so as to generate a second set of financial quantities corresponding to a different distribution of the assets, that is, a future portfolio. This future portfolio may or may not be acquired by the investor.

In order for changes to be made in the current portfolio, the table 501 comprises a column Q′ including a plurality of windows W₁-W_{N} and a column V′ including a plurality of windows D₁-D_{N}.

The windows W₁-W_{N} relating to each fund F₁-F_{N} can be filled in by the investor with a future number Qᵢ′ of shares. As will become clearer from the following, the future number Qᵢ′ of shares is the number of shares of the fund Fᵢ which the investor might purchase if he were to accept the changes made.

The boxes D₁-D_{N} relating to each fund F₁-F_{N} can be filled in by the investor or by the server computer 120 with an expected equivalent value Vᵢ′ equal to the product of the new number of shares Qᵢ′ and the latest price Pᵢ of the fund in question.

The table 501 preferably comprises a window NF 502 which, if selected by the investor, displays a list of investment funds, from which it is possible to select one or more funds to add to the portfolio.

The web page 500 also includes a summarized representation of a future portfolio FT-PORTF 505 of the investor.

The future portfolio is a portfolio which takes account of the values which are present in the windows W₁-W_{N}, D₁-D_{N}, and of any funds added, which the investor might purchase if he were to accept the changes.

FIG. 5 shows a button RST 506 for cancelling the changes made in the table 501 and a button SBT 507 for confirming the changes.

The web page 500 advantageously comprises a further table 508 which gives the total TOT of the future portfolio which is equal to the total of all of the resources invested in the future portfolio. This table also shows the current amount CL of financial resources present in the investor's supporting current account and the future amount PL of financial resources available in the investor's supporting current account after any investments made in order to acquire the future portfolio.

In step CURR 405, the web page 500 of FIG. 5 appears to the investor in a configuration in which the windows W₁W_{N} and D₁-D_{N} of the columns Q′ and V′ are empty, whereas the other columns contain the values of the financial quantities corresponding to the investor's current portfolio.

In this step 405, the summarized representations 503 and 505 show the same distribution of the assets corresponding to that of the current portfolio and the current amount CL is equal to the future amount PL.

In a step MOD 406, the investor can introduce changes to the web page 500 with the use, for example, of the keyboard 250 and the mouse 255.

Advantageously, the investor can select to introduce the changes to the web page 500 by entering the future number Qᵢ′ of shares or by entering the estimated equivalent value Vᵢ′ of the investment funds in which he is interested.

With reference to the equivalent value, the investor can fill in the box of the column V′ for each fund by inserting the estimated equivalent value Vᵢ′.

It will be clear to an expert in the art that, for a given price Pᵢ, a reduction in the future equivalent value Vᵢ′ relative to the current equivalent value Vᵢ corresponds to a financial transaction in which shares relating to the fund Fᵢ are sold, whereas an increase in the future equivalent value Vᵢ′ relative to the current equivalent value Vᵢ corresponds to a financial transaction in which shares in the fund are purchased.

The investor can also cancel out (realize) the shares invested in a certain fund and/or can add a new fund to his portfolio by means of the box 502; this latter operation may be repeated several times so as to add several new funds to the portfolio.

The changes introduced by the investor result in the web page 500 containing information relating to a second set of financial quantities. Each financial quantity can be associated with a certain investment fund.

After these changes have been introduced, the investor sends the corresponding data to the server computer 120 by means of the client computer 110. This data-transmission step SND 407 comprises, for example, the selection of a refresh button REF 509 present on the page 500 by means of the mouse 255.

In the next processing step, ELB 408, the data received by the server computer 120 is collated in the collating module INV-REC 326.

The calculation module PORT 327 retrieves this data from the collating module INV-REC 326 and, on the basis of the values of the second set of financial quantities received, and on the basis of the data relating to the investor's assets, establishes the number of future shares Qᵢ′ or the expected equivalent value Vᵢ′, according to the financial quantity set by the investor in step MOD 406.

The latest available price Pᵢ for each fund is considered for this calculation.

The server computer 120 also establishes the future portfolio, the total TOT of the future portfolio and the future amount PL of financial resources available in the investor's supporting current account.

It is pointed out that this step ELB 408 may alternatively be performed in the client computer 110, for example, after the investor has loaded a suitable program made available on the telecommunication network 105 by the server computer 120.

In a subsequent step COMP 409, the server computer 120 sends to the client computer 110 a web page 500′ shown in FIG. 6, which is displayed for the investor.

The web page 500′ corresponds to the configuration adopted by the web page 500 as a result of the calculations performed by the server computer 120.

This page 500′ gives the same values of the first set of quantities relating to the current portfolio and the same summarized representation 503 and, in addition, gives the second set of financial quantities relating to the future portfolio and the corresponding summarized representation of this portfolio FT-PORTF 505′.

For example, it may be considered that, in step MOD 406, the investor has made changes in the quantities of three funds F₁, F₂, Fₘ. The future numbers of shares Qᵢ′, Q₂′, Qₘ′ and the future equivalent values V₁′, V₂′, Vₘ′ calculated by the server computer 120 on the basis of the quantities entered by the investor are shown in columns Q′ and V′, respectively.

Naturally, although the method described is particularly advantageous when the investor makes several changes, the investor may even make only one change to a financial quantity of a single fund.

In FIG. 6, the future portfolio has a summarized representation FT-PORTF 505′ from which it can be inferred that it comprises 60% of the resources invested in FAC funds, 20% invested in FCO funds, 20% in FCB funds and 0% in MMF funds.

The quantities TOT, CL and PL calculated are also shown in the web page 500′, in the table 508.

It is pointed out that the web page 500′ is particularly advantageous since it allows the investor to compare the current portfolio 503 with the future portfolio 505′ and to assess, from the table 508, how much his changes affect his assets.

In a subsequent step CONF 410, the investor can decide not to accept this future portfolio and to return to step MOD 406. This return to step MOD 406 can take place by the entry of new data in the page 500′ or by the selection of the cancellation button RST 506 which cancels the changes entered and causes a web page corresponding to the page 500 to be displayed.

Alternatively, the investor can accept the future portfolio and send to the server computer 120 a comprehensive order confirming the changes previously introduced.

The comprehensive order confirming the changes can be transmitted by selecting the send button SBT 507 with the mouse 255. As a result of this selection, the drive module (M-DRV) 305 which physically controls the transmission of data on the telecommunication network 105 by means of the MODEM, will arrange for a signal corresponding to the order to be sent to the server computer 120.

As a result of this confirmation order, the particular method described goes on to an acceptance step ACC-ORD 411 in which the server computer 120 sends to the client computer a recapitulatory representation of the changes introduced. This representation may, for example, be a table displayed by means of a web page similar to the page 500′, on which the financial quantities belonging to the first and second sets defined above, but relating solely to the investment funds which have been changed, are given. This recapitulatory representation also enables the investor to accept or reject the changes individually before they are made and comprehensively confirmed at preliminary level. This may take place, for example, by the selection, by means of the mouse 255, of all or only some suitable boxes placed adjacent the financial quantities of each fund. According to the specific example, by selecting a particular box, the investor accepts the corresponding change, ratifying it, whereas if the box is not selected, the change is correspondingly not ratified and hence is finally rejected.

After the acceptance or rejection step, an order accepting at least some of the changes introduced during step MOD 406 is sent to the server computer 120 by pressing a button similar to the button SBT 507 of the page 500′ and provided on the respective web page. This acceptance order is sent together with the accepted financial quantities of the second set.

This acceptance order represents a request by the investor to the service centre to execute the financial transactions corresponding to the accepted changes.

It is pointed out that the step ACC-ORD 411, which is provided not only for reasons of a technical nature but also for legal and fiscal reasons, may take forms other than that described, in dependence on the regulations for the sector which are in force in the country in which the method is used. Moreover, insofar as the regulations in force in a specific country allow, this acceptance/rejection step could be omitted and the general confirmation order sent to the server computer 120 in step CONF 410 could itself represent the investor's request to execute the financial transactions corresponding to the changes. Moreover, the acceptance step ACC-ORD 411 may comprise a further investor identification step similar to that described above.

After the ACC-ORD step 411, the investor can disconnect himself from the INTERNET network, step DCNT 411′.

In a subsequent step ISTR 412, the acceptance order received by the server computer 120 is sent, by means of the collating module INV-REQ 326 and the calculation module PORT 327, to the order-management module MNG 328.

This order management module MNG 328 generates a plurality of instructions on the basis of the acceptance order and on the basis of the values of the financial quantities corresponding to the current portfolio and to the future portfolio. Each instruction corresponds to a financial transaction which is to be executed by the individual fund manager in order to fulfil the investor's request.

Each instruction thus generated, bearing all of the information necessary to define it, is sent to the individual managers G₁ 130 and G₂ 140 by means of the network 105.

In a step ACT 413, the managers execute the financial transactions indicated in the instructions received and the method described terminates in the step STP 419.

The method described enables a large number of financial transactions to be performed with a small number of exchanges of data between the client computer and the server computer. This reduces the time for which there is a connection between the investor and a service centre.

The order-management module MNG 328 preferably also enables the management of financial transactions to be deferred in time.

The management of an example of a financial transaction will be described with reference to FIG. 7, which shows some steps of the method illustrated in FIG. 4 which are alternatives to the steps ISTR 412 and ACT 413.

For example, it is assumed that, on a particular day, the service centre receives an acceptance order which is sent in an ACC-ORD step 411 and which corresponds to a request to execute a financial transaction composed of the sale of a given number of shares Qᵥ in a fund Fᵥ and of the purchase of shares in a fund F_{A} with the proceeds of this sale.

When the order is received by the server computer 120, the module MNG 328 generates an instruction corresponding to the sale of the shares Qᵥ in the fund Fᵥ, in a step SLL 414, and sends it to the corresponding fund manager.

In general, a service centre receives, each day, data relating to the prices of the funds and confirmation of transactions executed, but the price received relates to the previous day, whereas the confirmation of a transaction executed relates to a date to two or more days prior to the date on which it is received.

In the method according to the invention, before generating and sending the instruction corresponding to the purchase of shares in the fund F_{A}, the module MNG 328 waits, in a step DLY 415, for a period of time, for example, of one day which is required to know the price Pᵥ of a share in the fund Fᵥ on the date on which the sale was made.

After this waiting step DLY 415 which, typically, has a duration of one day, the order-management module is informed of the price Pᵥ and can calculate, in a step COMPT 416, the proceeds R=Pᵥ*Qᵥ resulting from the sale transaction.

In a subsequent waiting step DLY1 417, the module MNG 328 waits for a further period of time, for example, two or more days from the day on which it sent the sales order, until the computer associated with the fund-management company communicates to it that the sale transaction has taken place and that financial resources substantially equal to the proceeds R are available to the investor.

In this case, in a step ACQ 418, the module MNG 328 generates and sends an instruction to the fund manager FA requesting the purchase of a number of shares in that fund for an overall value substantially equal to the proceeds R. After a step ACT 413 similar to the step 413 described above, the method ends in the step STP 419.

It is pointed out that, although the foregoing description of a method and a system according to the invention has been given with reference to mutual funds, the teachings of the present invention may also be applied to investment products of other types. For example, further investment products are shares, bonds, money, or investments of an insurance nature. The adaptation of the method and of the system according to the invention to types of investment products other than mutual funds will be clear to an expert in the field of the foregoing description.

1. A method of performing financial transactions by means of a telecommunication network (105) comprising a client processing system (110) for association with an investor having predetermined assets and a server processing system (120) for association with a service centre, the method comprising the steps of:
identifying (404) the investor,
transmitting (405), from the server processing system to the client processing system, a first set of financial quantities associated with a first plurality of investment products purchased by the investor, the assets being distributed amongst the first plurality of products in a manner correlated with the quantities of the first set in order to define a first portfolio of the investor,
displaying (405, 500) the first set of financial quantities, under the control of the client processing system,
making (406) at least one change to the first set of financial quantities by means of the client processing system so as to generate a second set of financial quantities associated with a second plurality of investment products,
transmitting the second set of financial quantities to the server processing system,
establishing (408), under the control of the server processing system, a distribution of the assets amongst the second plurality of products in a manner correlated with the financial quantities of the second set in order to define a second portfolio,
displaying (409), under the control of the client processing system, a summarized representation (503) of the first portfolio and a summarized representation (505′) of the second portfolio which permit a comparison between the first portfolio and the second portfolio, and
transmitting (410) from the client processing system to the server processing system, a comprehensive order confirming the at least one change made, said at least one change defining at least one corresponding financial transaction.

2. A method according to claim 1 in which the telecommunication network comprises a network of the INTERNET type.

3. A method according to claim 2 in which the step of displaying the summarized representations comprises a step of displaying a single web page (500′) including the summarized representation of the first portfolio and the summarized representation of the second portfolio.

4. A method according to claim 1 in which the first and second pluralities of investment products comprise mutual funds.

5. A method according to claim 1 further comprising the steps of:
generating (412), under the control of the server processing system and on the basis of the comprehensive order confirming the changes made, at least one instruction for the execution of the at least one financial transaction, and
transmitting (412) the at least one execution instruction to at least one management processing system associated with at least one manager of investment products.

6. A method according to claim 1 further comprising, after the step of transmitting the comprehensive confirmation order, a step (411) for the display, under the control of the client system, of a recapitulatory representation of the at least one change,
the step of transmitting (411) an order ratifying the acceptance of the at least one change so as to order the execution of the at least one financial transaction,
the step of generating (412), under the control of the server processing system and on the basis of the order ratifying the acceptance, at least one instruction for the execution of the at least one financial transaction, and
the further step of transmitting (412) the at least one execution instruction to at least one management processing system associated with at least one manager of investment products.

7. A method according to claim 6 in which the at least one instruction comprises a first instruction corresponding to a financial transaction relating to a first investment product and a second instruction corresponding to a financial transaction related to a second investment product, the method comprising the steps of:
transmitting the first instruction from the server system to a first processing system associated with a first manager,
receiving, at the server system and from the first manager, a confirmation of the execution of the financial transaction,
generating, under the control of the server system and after the receiving step, a second instruction relating to a second investment product, and
transmitting the second instruction to a processing system associated with a second manager of the second product.

8. A method according to claim 7 further comprising a step of receiving, at the server processing system, the value of the price of a share in said first investment product evaluated on the date on which the first instruction was transmitted.

9. A method according to claim 4 in which the first set of financial quantities comprises a number of shares in a mutual fund.

10. A method according to claim 4 in which the first set of financial quantities comprises the equivalent value of a share in an investment fund.

11. A method according to claim 4 in which the at least one change defines a financial transaction comprising the sale or the purchase of at least one share in a first fund.

12. A method according to claim 1 in which the step of transmitting a first set of financial quantities to the client processing system comprises a step of retrieving the financial quantities from a database associated with the server processing system.

13. A method according to claim 1 in which the identification step comprises a step of comparing a code transmitted to the server processing system with an identification code of the investor stored in a database (330).

14. A method according to claim 1 in which the changing step comprises a step of typing in at least one financial quantity of the second set on a keyboard of the client processing system.

15. A method according to claim 4 in which the step of making changes comprises a step of adding an investment fund other than the funds included in the first plurality.

16. A computer program which can be loaded directly into a working memory of a server processing system, coupled through a telecommunication network to a client processing system associated with an investor, in order to perform the following steps:
identifying the investor,
transmitting, from the server processing system to the client processing system, a first set of financial quantities associated with a first plurality of investment products purchased by the investor, the assets being distributed amongst the first plurality of products in a manner correlated with the quantities of the first set in order to define a first portfolio of the investor,
displaying at the client processing system the first set of financial quantities,
receiving a second set of financial quantities associated with a second plurality of investment products at the server processing system, said second set including at least one change to the first set of financial quantities made at said client processing system,
establishing, under the control of the server processing system, a distribution of the assets amongst the second plurality of products in a manner correlated with the financial quantities of the second set in order to define a second portfolio,
displaying, at the client processing system, a summarized representation of the first portfolio and a summarized representation of the second portfolio which permit a comparison between the first portfolio and the second portfolio, and
receiving from the client processing system at the server processing system, a comprehensive order confirming the at least one change made.

17. A computer program according to claim 16 further performing the steps of:
generating, on the basis of the comprehensive order confirming the changes made, at least one instruction for the execution of the at least one financial transaction, and
transmitting the at least one execution instruction to at least one management processing system associated with at least one manager of investment products.

18. A computer program according to claim 16 further performing the steps of:
displaying, at the client processing system, of a recapitulatory representation of the at least one change, the at least one change defining at least one corresponding financial transaction,
receiving from the client processing system an order ratifying the acceptance of the at least one change so as to order the execution of the at least one financial transaction,
generating, under the control of the server processing system and on the basis of the order ratifying the acceptance, at least one instruction for the execution of the at least one financial transaction, and
transmitting the at least one execution instruction to at least one management processing system associated with at least one manager of investment products.

19. A computer program as in claim 18 in which the at least one instruction comprises a first instruction corresponding to a financial transaction relating to a first investment product and a second instruction corresponding to a financial transaction relating to a second investment product, the program performing the steps of:
transmitting the first instruction from the server system to a first processing system associated with a first manager,
receiving, from the first manager, a confirmation of the execution of the financial transaction,
generating, after the receiving step, a second instruction relating to a second investment product, and
transmitting the second instruction to a processing system associated with a second manager of the second product.

20. A system for performing financial transactions by means of a telecommunication network, comprising:
a server processing system for association with a service centre,
an investors data base accessible by said server and storing investors identifiers and financial information related to assets of said investors,
said server being programmed to perform, by interaction, through said telecommunication network, with a client processing system which can be associated with an investor, the method of claim 1.

21. A system for performing financial transactions by means of a telecommunication network, comprising:
a server processing system for association with a service centre,
an investors data base accessible by said server and storing investors identifiers and financial information related to assets of said investors,
said server being programmed to perform, by interaction, through said telecommunication network, with a client processing system which can be associated with an investor, the method of claim 5.

22. A system for performing financial transactions by means of a telecommunication network, comprising:
a server processing system for association with a service centre,
an investors data base accessible by said server and storing investors identifiers and financial information related to assets of said investors,
said server being programmed to perform, by interaction, through said telecommunication network, with a client processing system which can be associated with an investor, the method of claim 6.

23. A system for performing financial transactions by means of a telecommunication network, comprising:
a server processing system for association with a service centre,
an investors data base accessible by said server and storing investors identifiers and financial information related to assets of said investors,
said server being programmed to perform, by interaction, through said telecommunication network, with a client processing system which can be associated with an investor, the method of claim 7.
